(19) United States
(12) Patent Application Publication
(10) Pub. No.: US 2025/0376229 A1
(43) Pub. Date: Dec. 11, 2025

(54) ELECTRIC SCOOTER WITH ENHANCED FEATURES

(71) Applicant: Bytech IP Holdings, LLC, Brooklyn, NY (US)

(72) Inventors: Victor Mizrahi, Brooklyn, NY (US); Eli Mizrahi, Brooklyn, NY (US); Solomon Mizrahi, Brooklyn, NY (US); Daniel Mizrahi, Brooklyn, NY (US)

(21) Appl. No.: 19/212,871

(22) Filed: May 20, 2025

Related U.S. Application Data
(63) Continuation-in-part of application No. 29/836,810, filed on Apr. 29, 2022, now Pat. No. D1075941.

(51) Int. Cl. B62J 6/026; B62J 50/22; B62K 21/12

(52) U.S. Cl. CPC B62J 6/026; B62J 50/22; B62K 21/12; B62K 2202/00

(57) ABSTRACT

An electric scooter includes a base for a rider, connected to a vertical shaft, the vertical shaft terminating at a bottom end in a housing for a front wheel and tire, the base further including a rear fender and wheel housing. The scooter further includes a handlebar structure attached to an upper end of the vertical shaft, with right and left side protrusions configured to be grasped by a user, the right and left side protrusions each including a circular light at their end, the handlebar structure further including a front headlight. On right and left sides of the base are provided arc-like light bars, and the rear housing is provided with an internal light source that, when turned on, projects a shape or logo in light onto a road or surface on which the scooter is ridden, a pre-defined distance behind the scooter.

### CROSS-REFERENCE TO OTHER APPLICATIONS

This application is a continuation-in-part of, and thus claims priority to, United States Design patent application Ser. No. 29/836,810 for “SCOOTER,” filed on Apr. 29, 2022, the complete disclosure of which is hereby fully incorporated herein by this reference.

### TECHNICAL FIELD

The present invention is directed to electric scooters, and, in particular, to an electric scooter with several enhanced illumination and other features to provide an enhanced riding experience.

### BACKGROUND OF THE INVENTION

Electric scooters have become very common. While there are various types of electric scooters, few if any include significant safety features, illumination features, or other features that make for a top level, enhanced riding experience.

What is needed is an electric scooter, with both enhanced safety features, robust dimensions, and features that provide an excellent riding experience for the rider.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a left side view of a first embodiment of a scooter (the “first scooter’) according to the present invention.

FIG. 2 is a left side perspective view of the first scooter.

FIG. 3 is a right-side view of the first scooter.

FIG. 4 is a front view of the first scooter.

FIG. 5 is a rear view of the first scooter.

FIG. 6 is a top view of the first scooter.

FIG. 7 is a bottom view of the first scooter.

FIG. 8 is a bottom view of a second embodiment of a scooter (the “second scooter”) according to the present invention.

FIG. 9 is a left side perspective view of the second scooter.

FIG. 10 is a rear view of the second scooter.

FIG. 11 is a left side view of the second scooter.

FIG. 12 is a front view of the second scooter.

FIG. 13 is a right-side view of the second scooter.

FIG. 14 is a top view of the second scooter.

FIG. 15 is a left side 3D rendering of the second scooter.

FIG. 16 is a left side perspective 3D rendering of the second scooter in a collapsed position.

FIG. 17 shows a touch screen of the second scooter.

FIG. 18 is a close-up photograph of the touch screen of an example of the second scooter, with the function of main controls superimposed on it in white letters.

FIG. 19 is a top view 3D rendering of the second scooter, showing the touch screen, the brake control, leather-like hand grips with end lights, base, top of front wheel housing, and top of front tire.

FIG. 20 is a transparent left side 3D rendering of the second scooter, showing the rear suspension and the batteries.

FIG. 21 is another left side 3D rendering of the second scooter.

FIG. 22 is a rear 3D rendering of the second scooter, showing a logo cut-out on the back of the rear fender, and also the projection onto the floor or street of light in the shape of the cut-out via an interior illumination.

FIG. 23 illustrates example tires used in the second scooter.

FIG. 24 is a top view 3D rendering of the second scooter, showing an example expanded width of the base.

FIG. 25A is a left side view of 3D renderings of two example scooters, with front headlight, handle end lights, base side safety lights, and rear logo-projection illumination, all as turned on for nighttime riding.

FIG. 25B is a magnified view of one of the example scooters shown in FIG. 25A.

FIG. 25C is a magnified view of the other example scooter shown in FIG. 25A.

FIG. 26 is a 3D rendering of an example charger for the second scooter, with a magnified view of the actual charging assembly.

FIG. 27 is a close up of the charger rendering of FIG. 26, showing the charging progress indicators.

FIG. 28 is a left side 3D rendered view of the second scooter with key enlarged dimensions indicated.

### DETAILED DESCRIPTION OF THE INVENTION

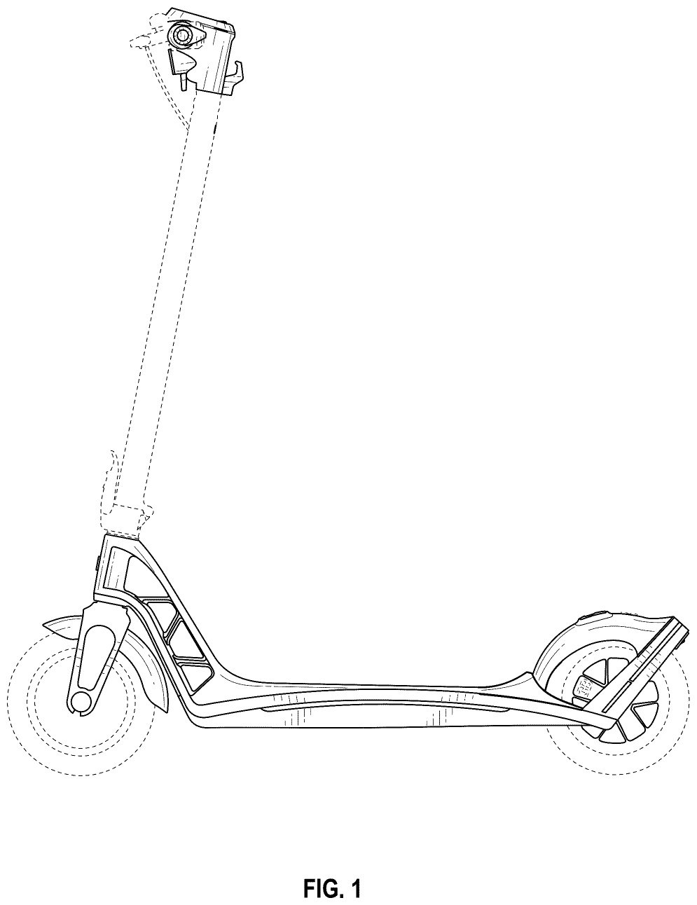

As noted above, FIGS. 1-7 illustrate a first embodiment of a scooter that was the subject of U.S. Design patent application Ser. No. 29/836,810 for “SCOOTER,” filed on Apr. 29, 2022. With reference to FIG. 1, there is shown an electric scooter according to a first embodiment. The scooter has a base, on which a user stands, shown as a horizontal structure at the bottom of FIG. 1. The rear of the base has a housing for a rear wheel and tire. Integrated at the front of the scooter is a vertical shaft, which has a pickle fork termination at its bottom side, which serves as a holder for a front wheel and tire. There are fenders on both he front wheel housing and the rear wheel housing. The vertical shaft can be turned to steer the scooter, by means of two handlebars, as described below. There is also a graspable brake control attached to the left handlebar, for example.

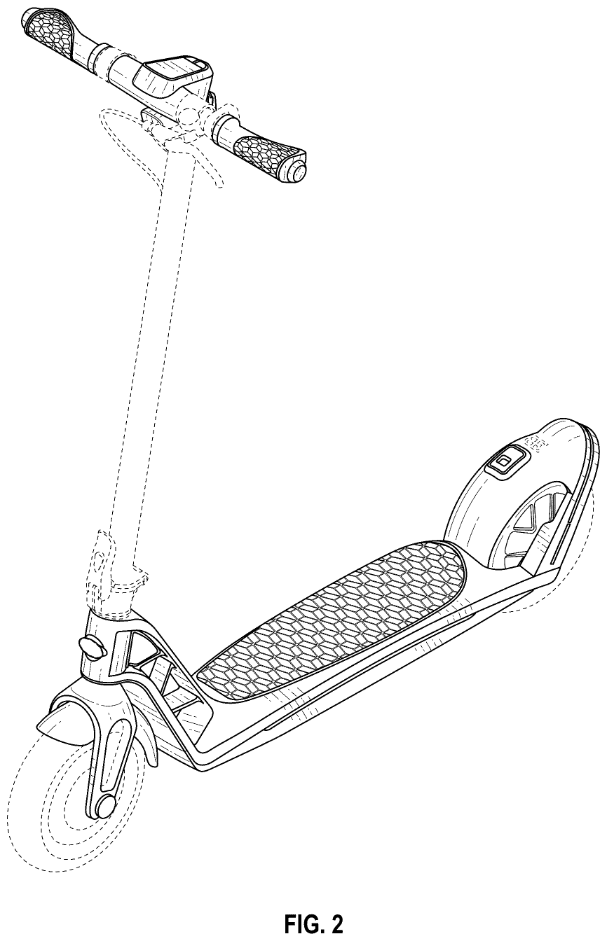

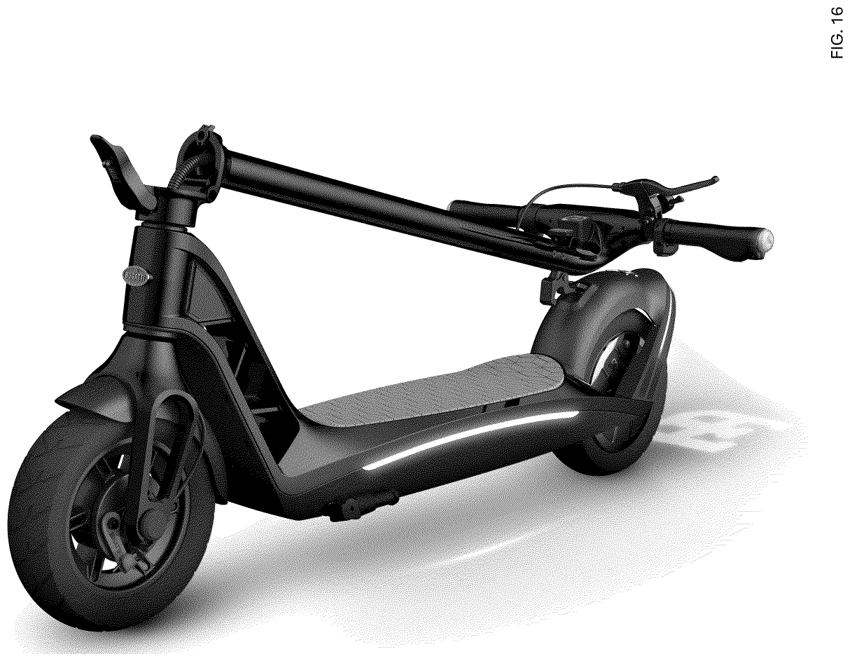

FIG. 2 is a left side perspective view of the first scooter. Here the full width of the base is seen, with a unique design embodied in the top of the base. This design is echoed in the grips at the end of each handlebar, as shown. More complete views of the front and rear fenders are also seen in this figure. Also shown, at the bottom of the vertical shaft, just above where it connects to the vertical tubular structure at the front end of the base, is a clasp to hold the shaft upright. As described below, the scooter may be collapsed into a folded-over configuration, by releasing this clasp, and rotating the vertical shaft backwards and downwards to fold over the top of the base (or more precisely, over the top of the rear fender), where it may be clasped. Such a folded over configuration is shown, for example, in FIG. 16, described below.

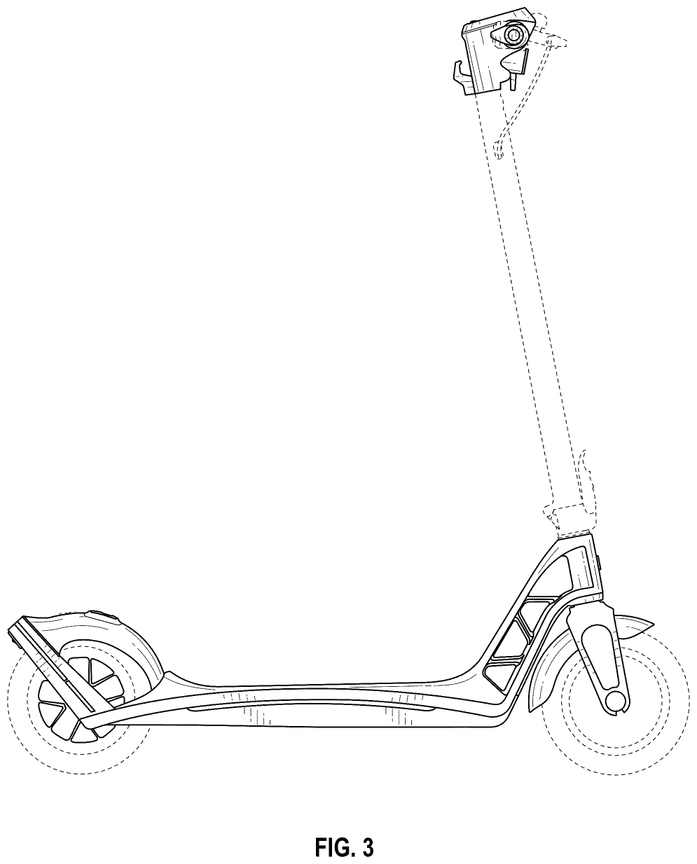

FIG. 3 is a right-side view of the first scooter, which is substantially a mirror-image of what is shown in FIG. 1.

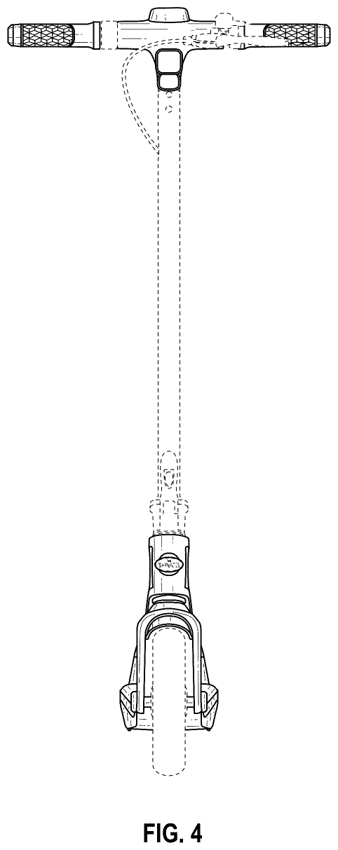

FIG. 4 is a front view of the first scooter, showing a logo on the front of the tubular structure that mates with (receives) the vertical shaft, and a view of the pickle-fork end of the vertical shaft, through which the front wheel is provided.

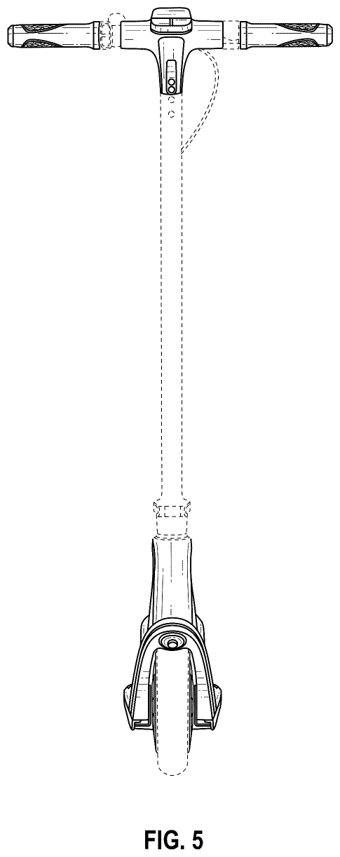

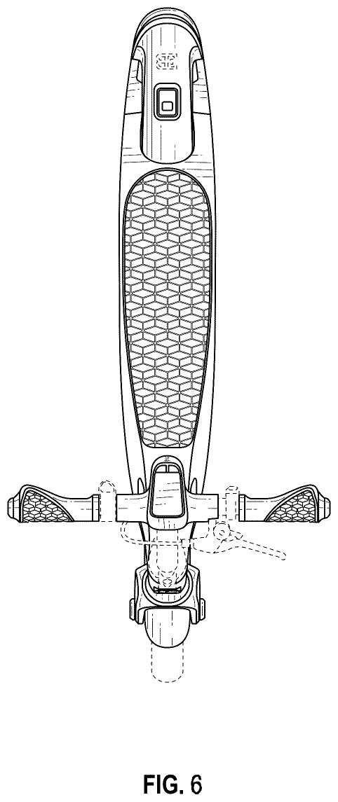

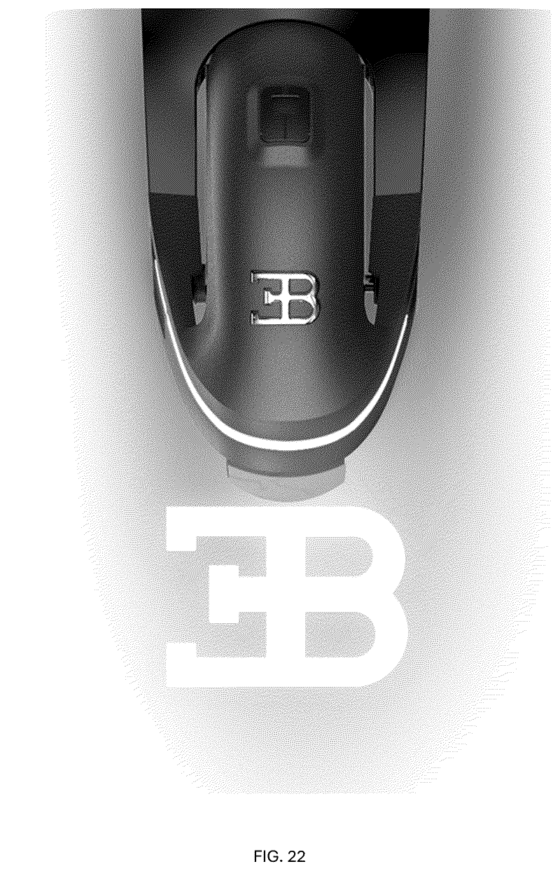

FIG. 5 is a rear view of the first scooter. FIG. 6 is a top view of the first scooter, which, when taken together with FIG. 2, shows the relative positions of the various sub-structures of the scooter. In particular, shown in FIG. 5, at the back of the rear fender, a recessed opening through which an interior lit logo may be projected onto the floor or street behind the scooter. This is discussed in detail below, with reference to FIG. 22.

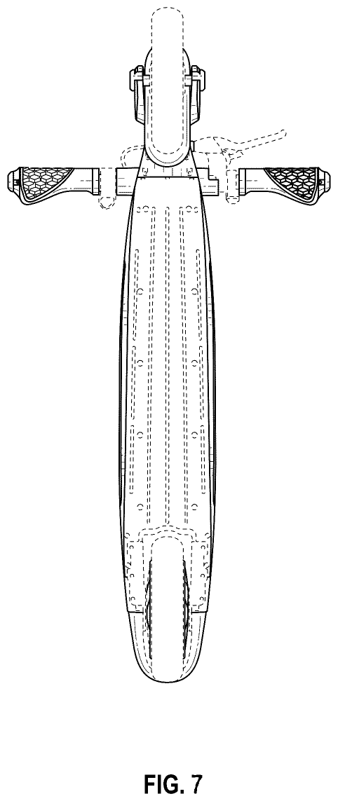

Finally, FIG. 7 is a bottom view of the first scooter. Here is seen the underside of the base, the respective undersides of the two handlebars, the underside of the brake control handle, and the tires.

Next described are details of an exemplary scooter according to a second embodiment, which has additional safety features, as well as other features which, taken together, increase the rider experience to provide a use with a top level experience.

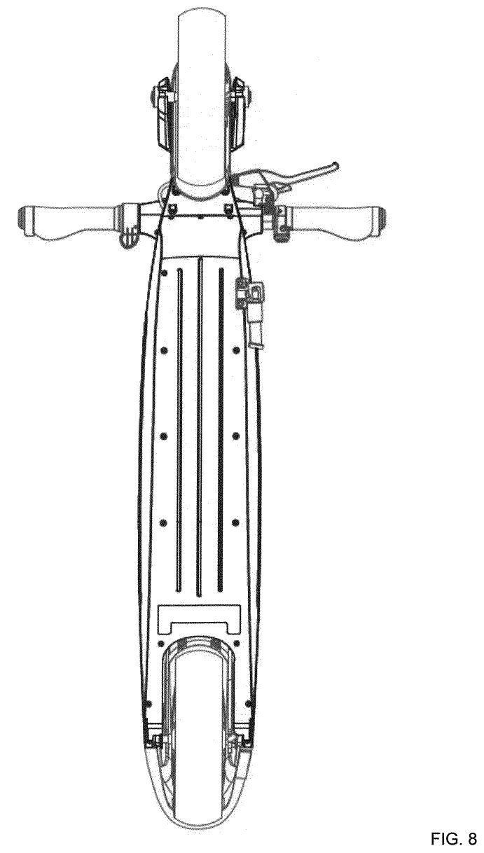

FIGS. 8-15 are line drawings of the second scooter, similar in type to those of FIGS. 1-7 for the first scooter. Then, FIGS. 16-25C present 3D renderings of an example of the second scooter, which, together with FIGS. 8-15, allow the reader to more clearly form a mental image of the second scooter and its features.

FIG. 8 is a bottom view of the second scooter, and this view is analogous to that shown in FIG. 7 for the first scooter. FIG. 8 shows the underside of the base, the undersides of the two handlebars, the underside of the brake control handle, and the wheel housings and tires.

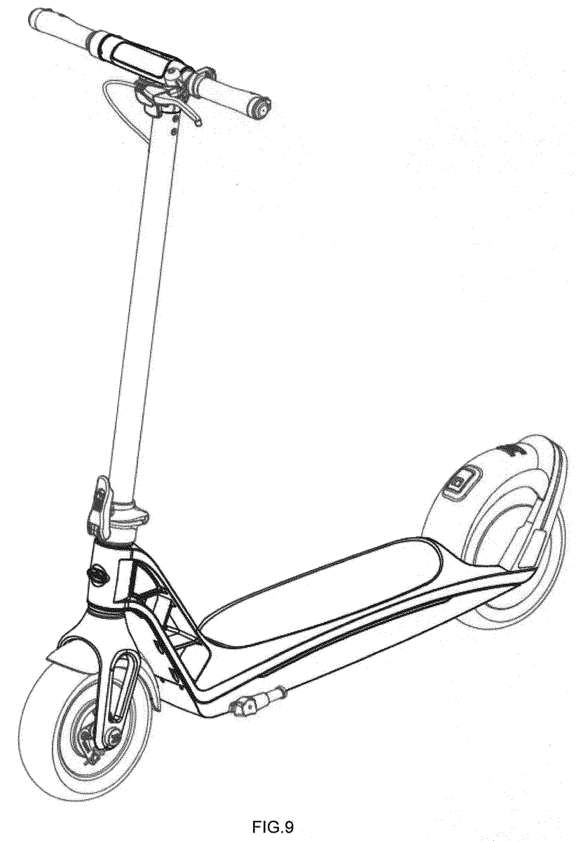

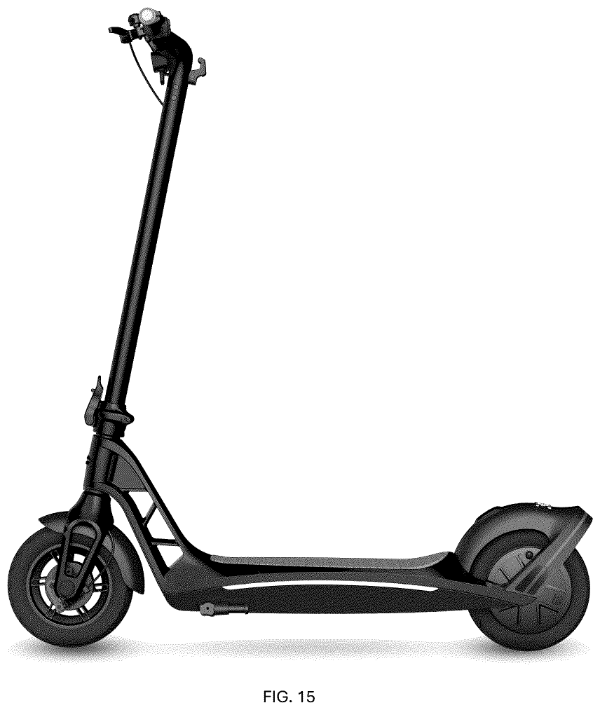

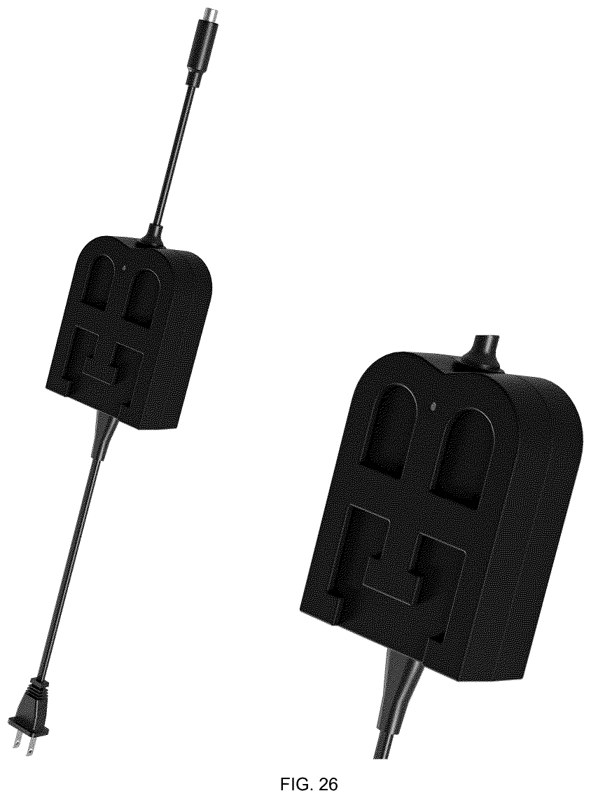

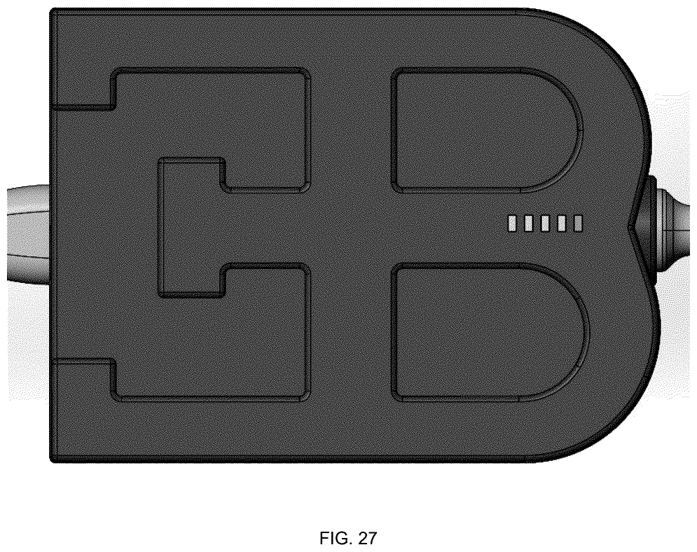

FIG. 9 is a left side perspective view of the second scooter. Here the full length and width of the base is seen, as well as more complete views of the front and rear fenders are also seen in this figure. As shown, the base has a top pad, which may have a trade dress design on it, on which the rider stands when riding. As also shown in FIG. 9, the front fender is attached to a bottom side of the pickle-fork end of the vertical shaft. As also shown, at the bottom of the vertical shaft, just above where it connects to the vertical tubular structure at the front end of the base that holds it, is a clasp to hold the shaft upright. As described below, the scooter may be collapsed into a folded-over configuration by releasing this clasp, and rotating the vertical shaft backwards and downwards to fold over the top of the base (or more precisely, over the top of the rear fender) where it may be clasped, for example. Such a folded over configuration is shown, for example, in FIG. 16, described below. Also shown on the top front of the rear fender is a device to clasp the vertical shaft when it is collapsed, as shown in Fig, 16. Finally, at the front portion of the bottom of the base, there is a charging interface to charge the internal battery pack. (This is shown in grey, at the very bottom of the side of the base, below the front end of the arc-shaped light bar, in the rendering of FIG. 15). This may, for example, mate with an end piece of a charging cable or wire, as shown in FIGS. 26 and 27, and discussed below. The mating may be female type receptacle on the base to a male type charging cable protrusion, as shown in FIG. 26, or it may be the reverse, for example.

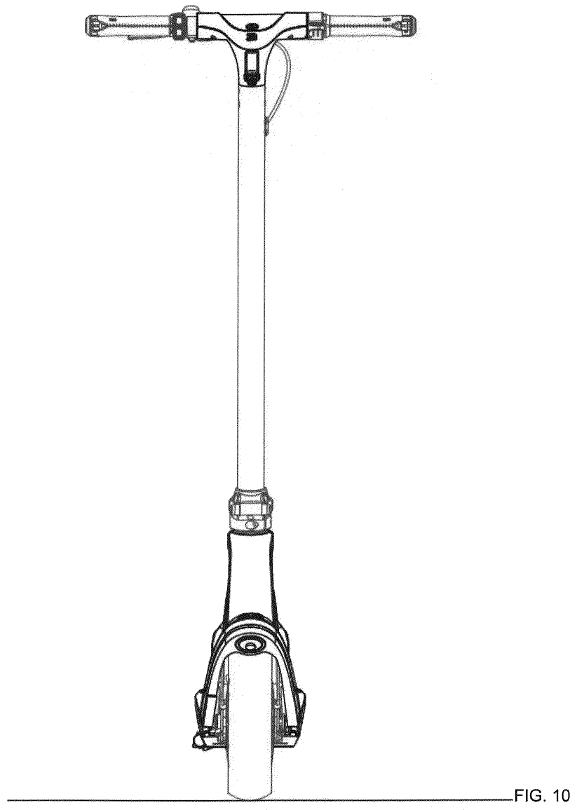

FIG. 10 is a rear view of the second scooter. Once again, shown in FIG. 10 at the back bottom of the rear fender, is a recessed opening through which light from an interior light in the fender structure may be projected onto the floor or street behind the scooter. In one example, the light orifice may be in the shape of a logo, as is discussed in detail below, with reference to FIG. 22.

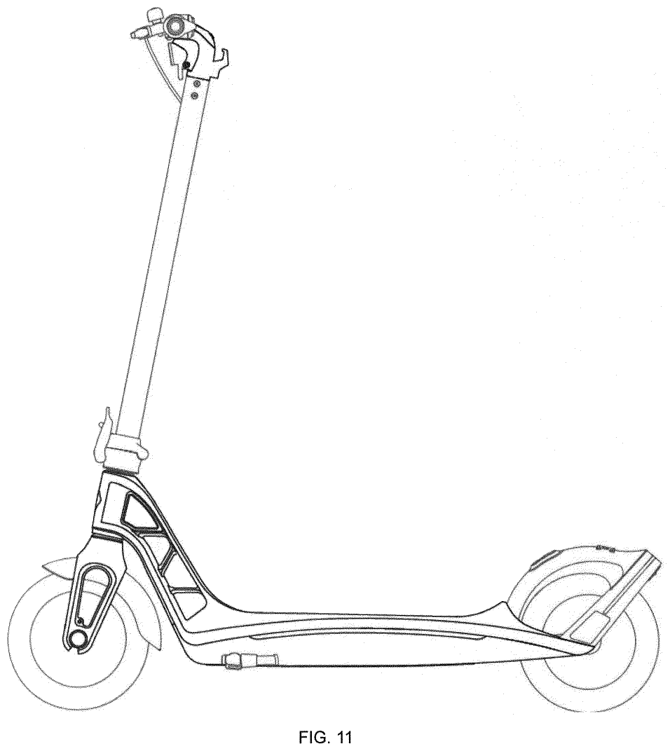

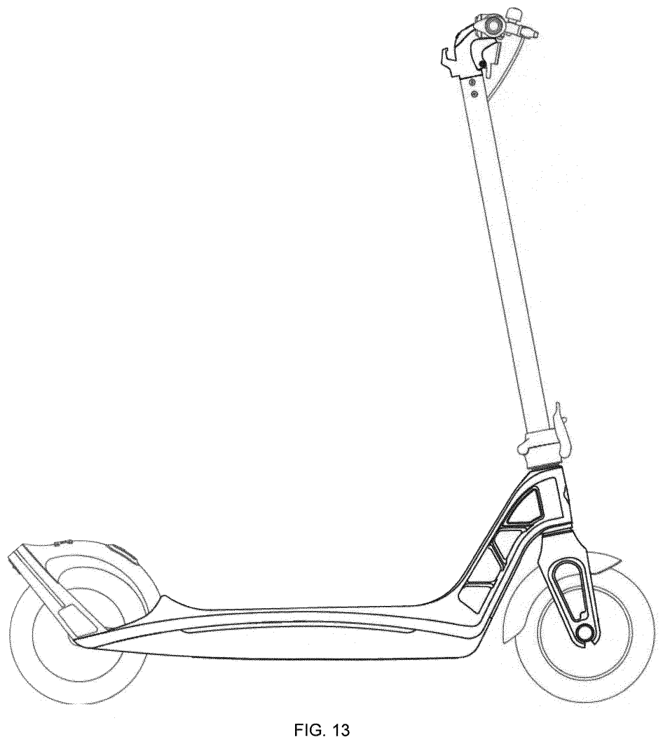

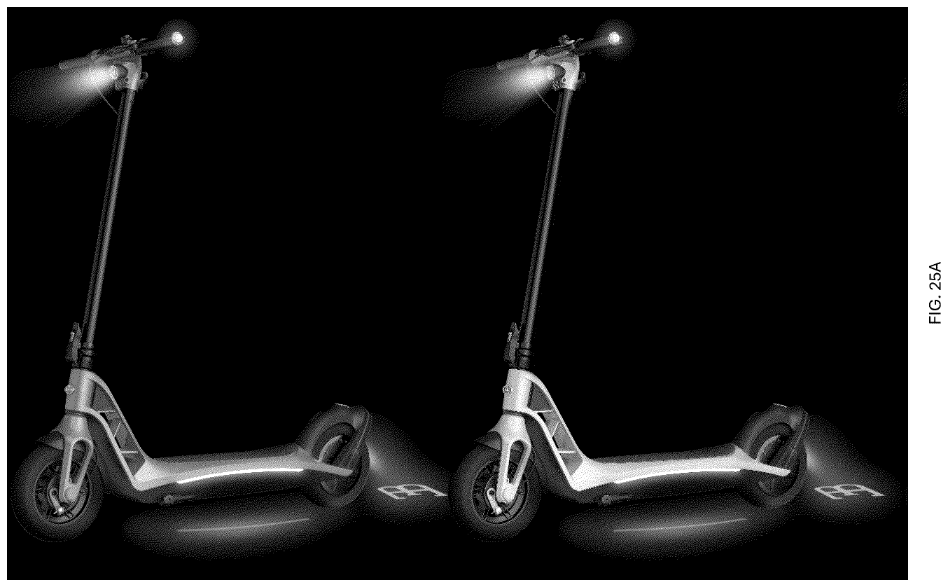

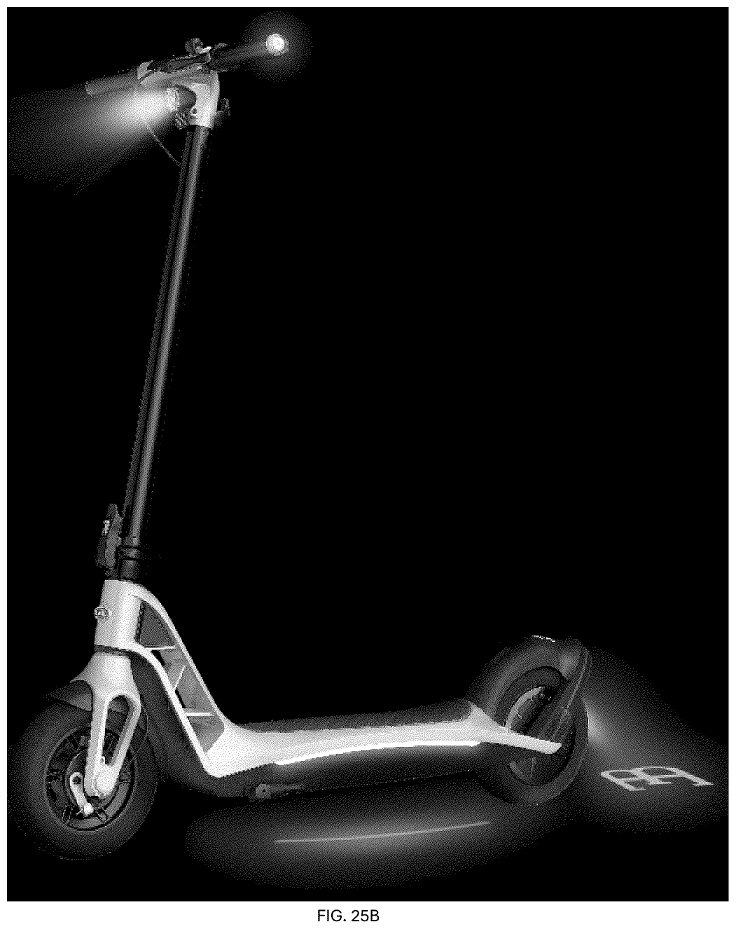

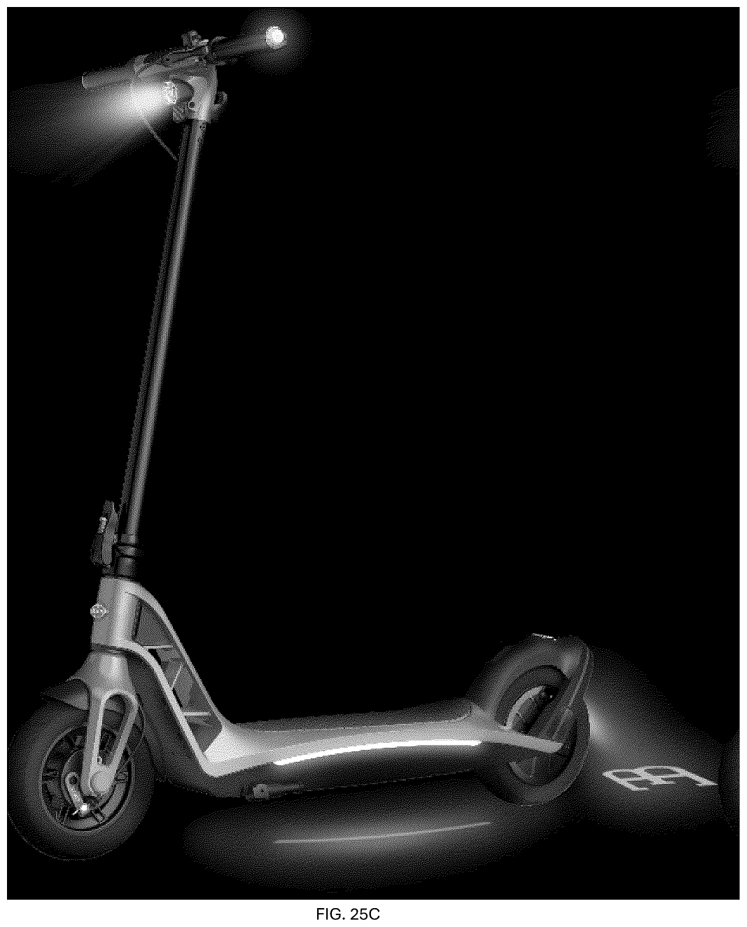

FIG. 11 is a left side view of the second scooter, and FIG. 13 is a right-side view of the second scooter. As shown in these figures, at the end of each of the handlebars is a light, which may be used, for example, during night-time riding, to provide illumination, and make the scooter viewable by other vehicles on a street or road. Also, as seen on both sides of the base there is a smaller and thinner arc-like structure provided on each side of the base. This arc-like structure is a safety light for use when, for example, riding at night, or in fog, or the like. The base safety lights are shown in more detail in FIGS. 25A, 25B and 25C, discussed below.

Also shown at the top front of the vertical shaft, just under the handlebars, in each of FIGS. 11 and 13, is a headlight. This is a safety light to both illuminate the road ahead for a rider, as well as to make the scooter visible to the other vehicles on the road or path. This headlight is shown in greater detail in FIGS. 25A, 25B and 25C, discussed below.

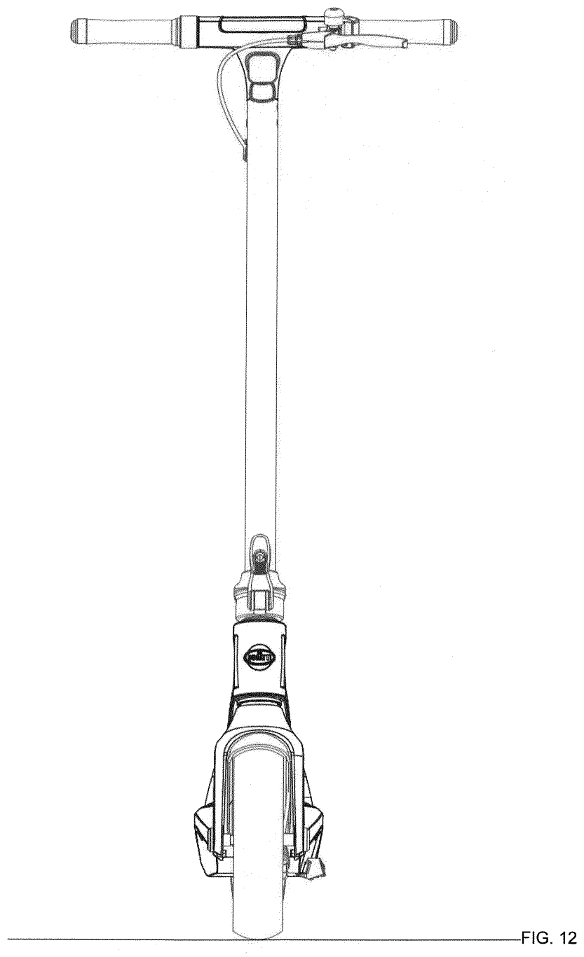

FIG. 12 is a front view of the second scooter, showing the headlight at the top of the vertical shaft, just under the handlebars. For example, the headlight may be connected to a connector that connects the handlebars to the vertical shaft (this connector is shown in yellow and blue in FIGS. 25A, 25B and 25C).

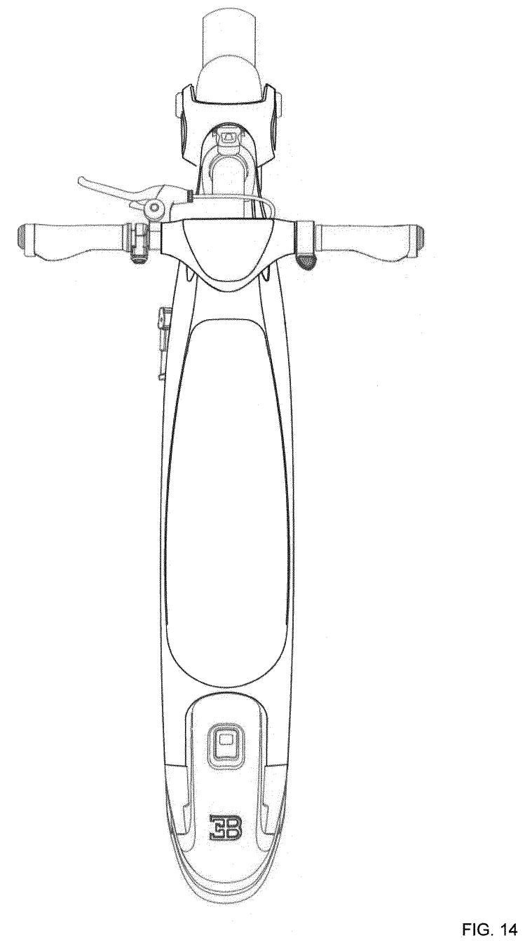

FIG. 14 is a top view of the second scooter. With reference to FIG. 14, at the bottom of the figure, is seen the top of the rear fender. This rear fender includes on its top a clasping mechanism for the vertical shaft when the vertical shaft is collapsed. This mates with the clasping protrusion provided on the top of the vertical shaft, facing the rider, under the touch screen, as noted above. Below the clasping mechanism, on the rear of the fender, a logo shaped orifice is provided. This cut-out or orifice is interior lit by a lamp or illumination device provide inside the fender housing. Thus, when the interior light is turned on, a light image in the shape of the logo is projected, through the orifice, out onto the surface of the road or other path the scooter is being ridden on, just behind the scooter. This is shown in greater detail in FIG. 22, described below.

Next described are FIGS. 15-28, which are all 3D renderings (or photographs) of an example of the second scooter. The 3D renderings give depth to the various depictions of the example of the second scooter.

FIG. 15 is a left side 3D rendering of the second scooter, this view is essentially the same as that of FIG. 11. The end light on the left handlebar is shown in yellow here, and the arc shaped light bar on the left side of the base is also shown. At the top of the vertical shaft, under the touch screen, facing the rider, is a clasping protrusion, for use when the vertical shaft is in a collapsed state.

FIG. 16 is a left side perspective 3D rendering of the example scooter of FIG. 15, but now in a collapsed configuration, where the vertical shaft has been rotated back and downwards, where it can be clasped in this position to a holding mechanism on the rear fender, as shown.

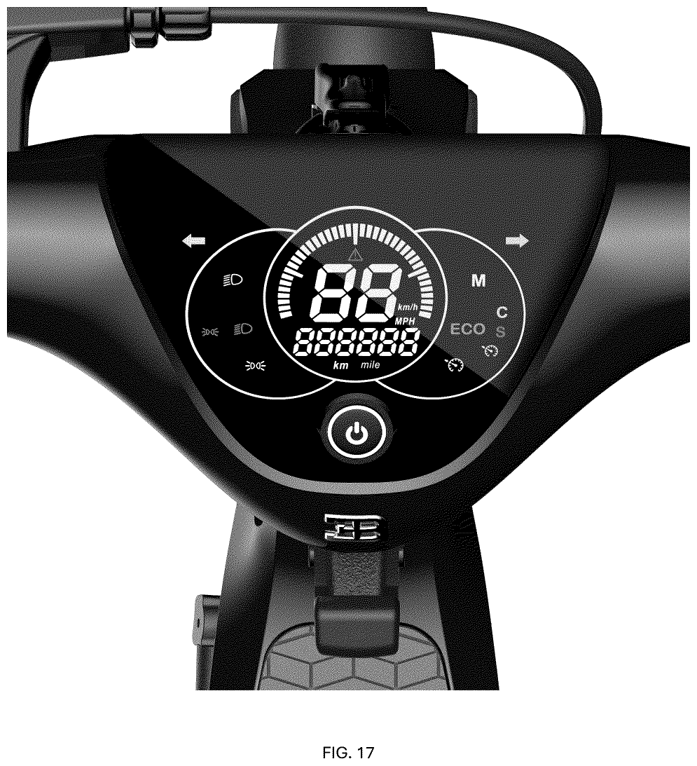

FIG. 17 shows an example touch screen of the second scooter. It has a flat screen, and is more sleek than conventional screens. For safety, the touch screen is seamless to a rider, avoiding potential visual disruption. In embodiments, the touch screen may be provided with a passcode interface, to avoid theft or other unauthorized use of the scooter. As shown, the touch screen has essentially three intersecting circular areas, and an on/off button below those. In the center is a speed indicator and odometer, to the left of the speedometer is a headlight control area, and to the right of the speedometer and odometer is a gear (mode of operation) switching area, with cruise control. Finally, at the bottom center, below the speed indicator/odometer, is the power on/off button.

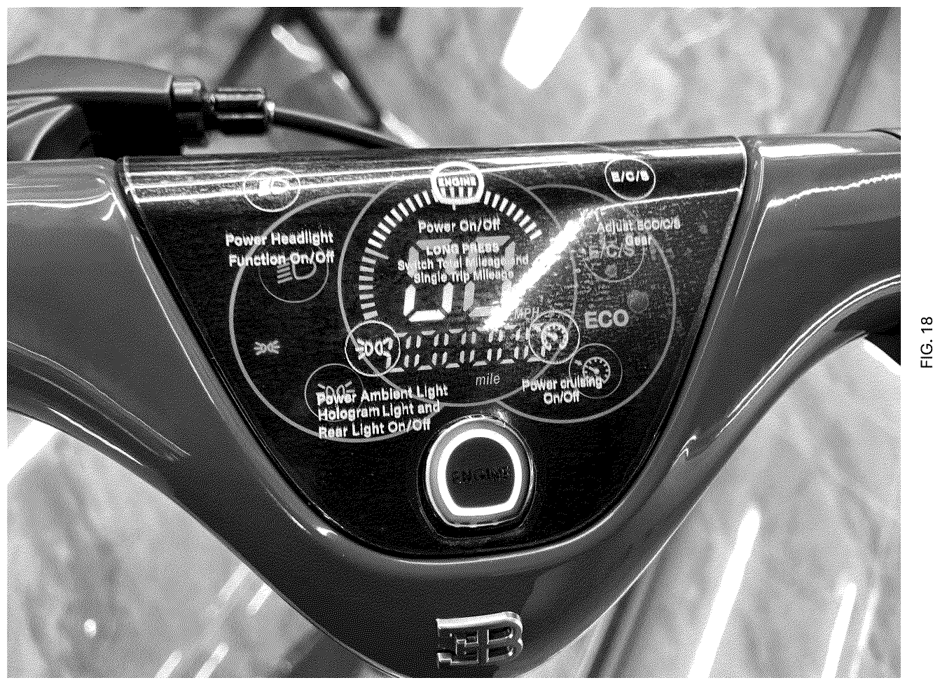

FIG. 18 is a close-up photograph of an example touch screen such as shown in FIG. 17, with the description of the controls superimposed on the image in white letters. Thus, starting at the left side, within the illumination control partial circle, at the top there is shown a power headlight on/off button. Below that are power ambient light, hologram light, and rear light on/off switches. Under the speedometer is the power on/off switch, as described above (the superimposed white letters describing this are provided at the top center and over the speedometer, as seen in FIG. 18), and, as those white words show, a function of long press to toggle the total mileage and trip mileage readouts of the odometer. At the right of the speedometer is another partial circle, which has the gear adjust interface, which allows a user to switch between “Eco”, “Comfort” and “Sport” (E/C/S) modes of riding, Eco being the “softest” and lower power/acceleration ride, and Sport being the “edgiest” with higher power/acceleration ride. Finally, at the bottom right of this rightmost partial circle is a power cruising on/off switch, as shown.

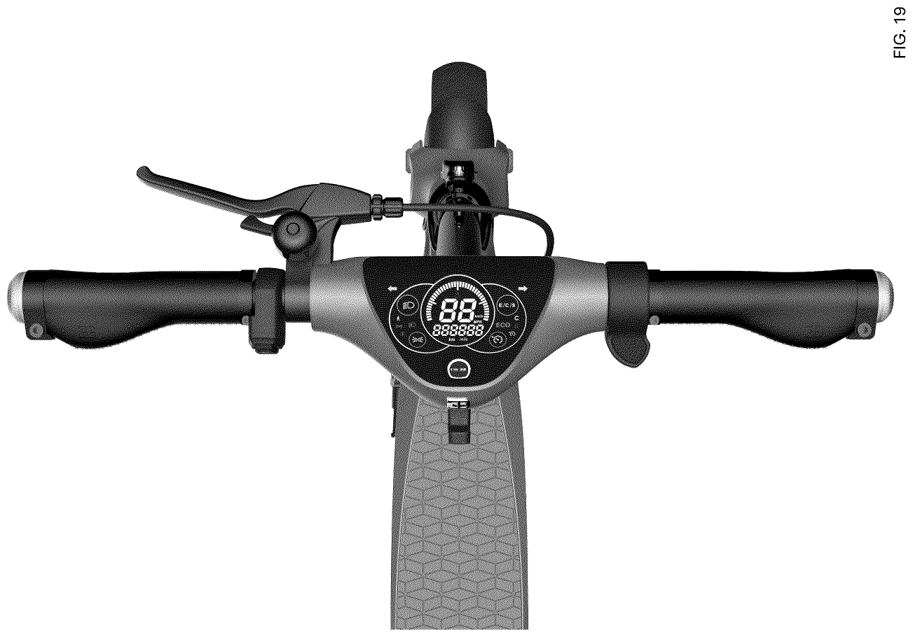

FIG. 19 is a top view 3D rendering of the second scooter, showing the touch screen and its parts, brake control on the left handlebar, handlebar grips, end lights on the handlebars, a portion of the base (the decorative top plate on the base is shown in grey), the front wheel housing (in blue) and the top of the front tire (in black). The leather like handlebars allow a user to better grip the handlebars grip for better comfort, as well as enhances the rider's grip for safer riding and control of the scooter. The leather-like grips may be made of any synthetic leather material, for example, including those used on automobile interiors and steering wheels.

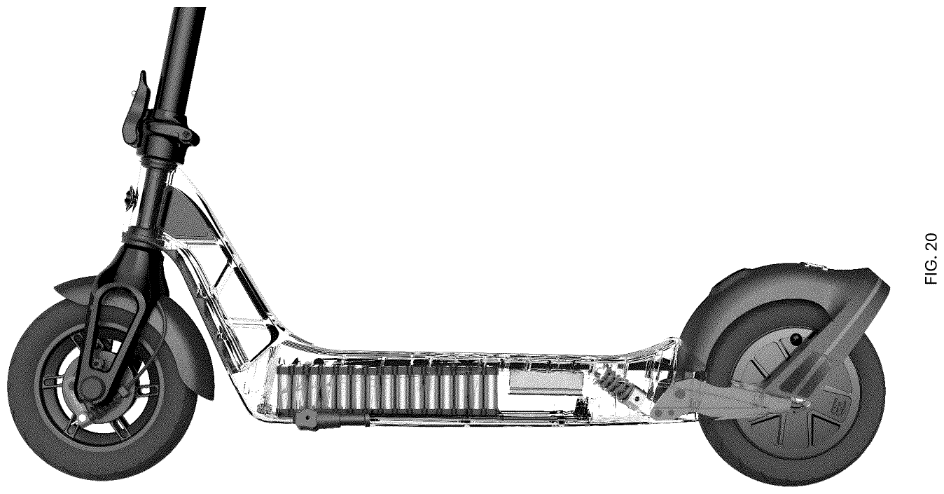

FIG. 20 is a transparent left side rendering of the second scooter, showing the rear suspension for the rear wheel (in red), and the batteries at the front of the base (shown in green). The built-in suspension provides a smoother riding experience, and enhances safety for uneven roads, or even off-road riding. At the front of the bottom of the side of the base, just below the battery pack (shown in grey), and internally connected to it, is the charging interface, discussed above.

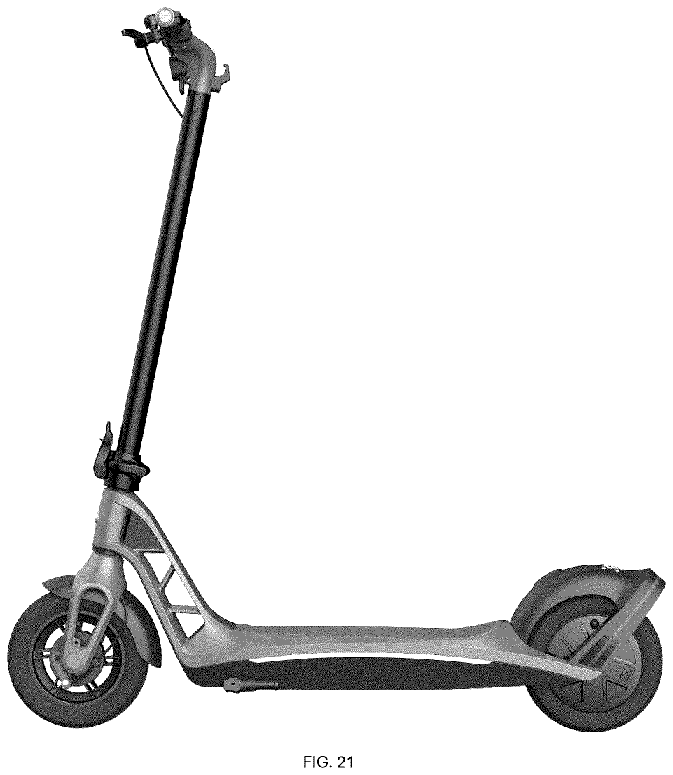

FIG. 21 is another left side 3D rendering of the second scooter, similar to that of FIG. 15, but here showing a different color for the base, pickle-fork front wheel assembly, and the base of the handlebar assembly, here all matching in an electric blue.

FIG. 22 is a close-up view of an orifice or a cut out, in the shape of a logo-here an upper case “B” on the right, back to back with a backwards upper case “E”-provided in the rear of the rear fender, so that a projection on the ground, path, road or other travel surface of that logo in light can be made just behind the scooter, as shown.

The light is sourced inside the fender assembly, so that the orifice is effectively an interior lit projection mechanism, like those flashlights that have a cover with a cutout in the shape of “batman's symbol” or some meaningful word, etc. In some embodiments, instead of a logo being projected, the cut out or orifice may be in some other custom shape, or spell out a word, or phrase, for example.

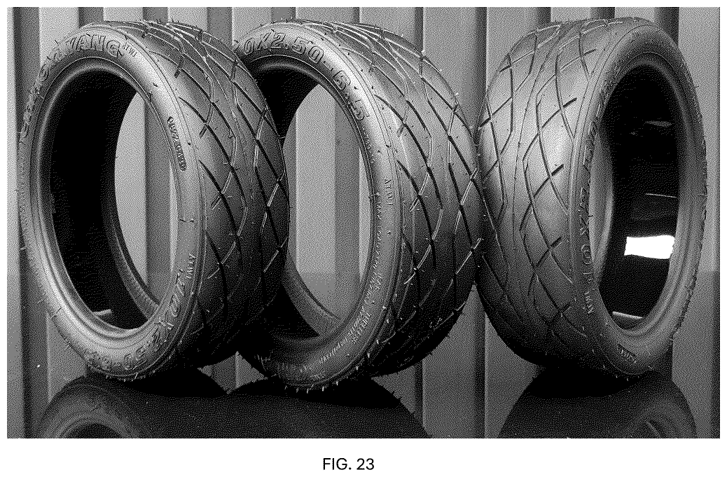

FIG. 23 illustrates example tires used in the second scooter. In embodiments, both tires may be self-repairing. In such embodiments, this avoids the stress of tire replacements for a rider, and provides a sense of security to venture out into sparsely populated areas.

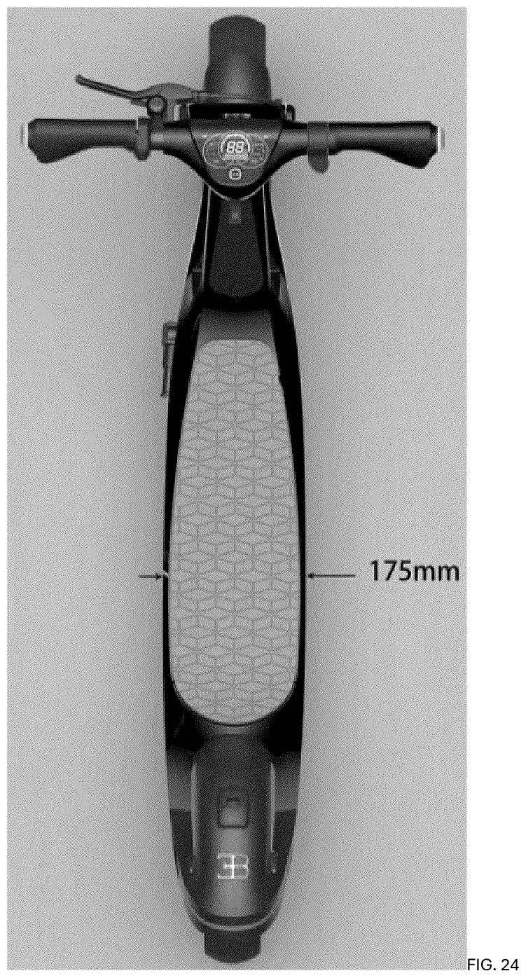

FIG. 24 is a top view 3D rendering of the second scooter, showing an example width of the base cover (where the rider stands, shown in grey) at 175 mm. In embodiments, the second scooter is both longer, wider and taller than conventional scooters. These larger dimensions provide safer legroom, and a smoother and more comfortable ride.

FIG. 25A is a left side view of 3D renderings of two example scooters, with headlight, handle end lights, base side arc shaped safety lights, and rear logo-projection illumination light all turned on.

FIG. 25B is a magnified view of the yellow, rightmost example scooters in FIG. 25A. As shown in FIG. 25B, the “backwards E back to back with B”, to be used in the branding of an example line of such scooters, is clearly projected onto the ground just behind the scooter. With this interior illumination light on, as the scooter travels down a road or path, everyone behind the scooter on said road or path can see the logo. As shown, the arc shaped side safety lights on each side of the base also project a similar arc of light on the road or other travel surface, as shown.

FIG. 25C is a magnified view of the blue, leftmost example scooter in FIG. 25A, and with the exception of a color change, everything else is the same as the yellow scooter of FIG. 25B. Thus, the safety lights on the sides of the base, the end cap lights on the handlebars, and the headlight, may in embodiments, all stay on for visual recognition of the scooter's width at night. This is especially important given the larger dimensions, including larger width, of the second scooter. Collectively, these lights give others around the scooter a visual of the scooters width and length at night.

FIG. 26 is a 3D rendering of an example charger for the second scooter, with a magnified view next to it.

FIG. 27 is a close up of the charger of FIG. 26, showing several the charging progress indicator LEDs.

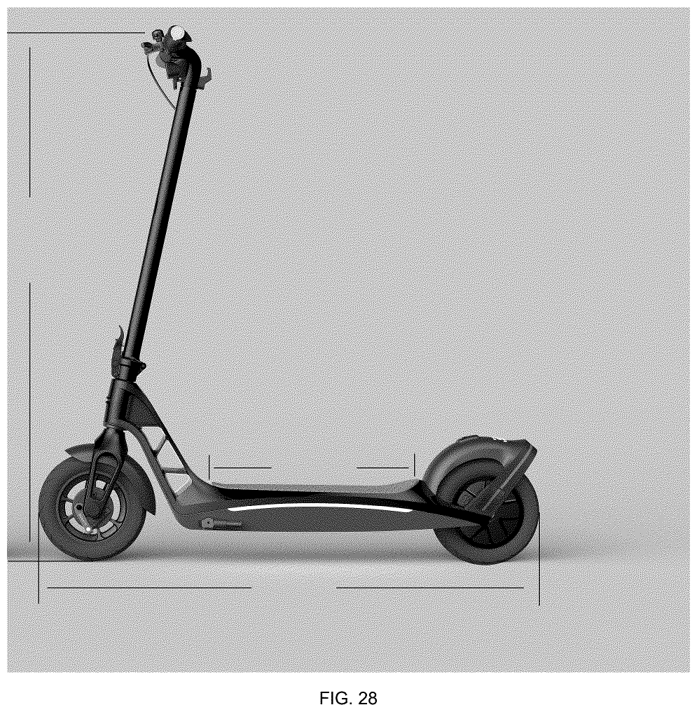

FIG. 28 is another left side 3D rendered view of the second scooter, here with key dimensions indicated, which include the scooter height (vertical dimension), the length of the base cap available to stand on (upper and shorter horizontal dimension), and the overall length of the scooter measured from front end of front tire to back end of rear tire (lower and longer horizontal dimension). Each of these dimensions, being expanded from conventional scooters, along with the wider base deck width described above (FIG. 24), provide for more comfort and safety, and safer legroom, all facilitating smoother and more comfortable riding.

Although particular embodiments, aspects, and features have been described and illustrated, it should be noted that the invention described herein is not limited to only those embodiments, aspects, and features, and it should be readily appreciated that modifications may be made by persons skilled in the art. The present application contemplates any and all modifications within the spirit and scope of the underlying invention described and claimed herein, and all such embodiments are within the scope and spirit of the present disclosure.

What is claimed:

1. A scooter, comprising:
a base configured to support a rider, the base configured to connect to a vertical shaft at a front portion of the base via a cylindrical tubular structure;
a rear housing including a rear fender, and a rear wheel and tire, the housing integrated in the base at a rear end of the base;
a vertical shaft, placed through the cylindrical tubular structure, the vertical shaft terminating at a bottom end in a pickle-fork structure provided with a front wheel and tire; and
a handlebar structure attached to an upper end of the vertical shaft, including right and left side protrusions configured to be grasped by a user when riding the scooter, each of the right and left side protrusions having an end including a circular light, the handlebar structure further including an attached headlight on a front end,
wherein the base is provided, on each of right and left sides of the base, with arc-like light bars, and wherein the rear housing is provided with an internal light source that, when turned on, projects, through an orifice at the rear of the rear housing, light onto a road or a surface on which the scooter is ridden upon, a pre-defined distance behind the scooter.

2. The scooter of claim 1, wherein the front tire and rear tire are self-repairing.

3. The scooter of claim 1, further comprising a flat touch screen interface.

4. The scooter of claim 3, wherein the flat touch screen interface has controls and a speedometer and odometer.

5. The scooter of claim 3, wherein the flat touch screen interface has a smooth surface, and may be used to control at least one of:
power headlight on/off, power ambient light, hologram light, and rear light on/off, scooter power on/off, or toggle between total mileage and trip mileage readouts of an odometer.

6. The scooter of claim 3, wherein the flat touch screen interface has a smooth surface, and may be used to at least one of:
switch between “eco”, “comfort” and “sport” modes of riding; or
turn power cruising on and off.

7. The scooter of claim 3, wherein the flat touch screen interface includes a passcode entry interface, wherein a rider enters a passcode in order to turn on the scooter.

8. The scooter of claim 1, wherein the base includes a rear suspension mechanism.

9. The scooter of claim 1, wherein the handlebars each have a leather-like grip, configured to improve a rider's grip.

10. The scooter of claim 1, wherein the orifice in the rear housing through which the light projects is in the shape of a logo, word, or phrase, such that an image, in light, of the logo, word or phrase is seen on the road behind the scooter.

11. The scooter of claim 1, further comprising a headlight attached to the front of the vertical shaft.
